(19) United States
(12) Patent Application Publication
(10) Pub. No.: US 2005/0263410 A1
(43) Pub. Date: Dec. 1, 2005

(54) Ion-selective electrodes and method of fabricating sensing units thereof

(75) Inventor: Stephen S. K. Hsiung, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Chung Yuan Christian University

(21) Appl. No.: 11/086,606

(22) Filed: Mar. 22, 2005

(30) Foreign Application Priority Data
May 28, 2004 (TW) 93115233

(51) Int. Cl. G01N 27/26

(52) U.S. Cl. 205/789; 204/416

(57) ABSTRACT

An ion-selective electrode and methods of fabricating a sensing unit therein, detecting potential using the electrode. The ion-selective electrode with an extended gate field effect transistor (EGFET) comprises a metal oxide semiconductor field effect transistor (MOSFET) installed on a semiconductor substrate, a sensing unit comprising a substrate, an oxide layer on the substrate, an ammonium ion selective film fixed on the oxide layer, and a conductive line connecting the MOSFET and the sensing unit.

### BACKGROUND

The present invention relates to an ion-selective electrode, and more specifically to an ion-selective electrode with an extended gate field effect transistor and a method of fabricating a sensing unit thereof.

Application of traditional glass electrodes has been limited due to limitations of micro-measurement, vulnerability, and lack of portability. Currently, an ion sensing field effect transistor (ISFET) provided by Piet Bergveld has been widely applied in minimized pH sensors and biomedical sensing units.

J. V. D Spiegel discloses an extended gate field effect transistor (EGFET), wherein a sensing film is installed on the end of a signal line extending from a FET gate, so that only the sensing film is required in the chemical environment for testing without the FET. Janata and Moss disclose an enzyme field effect transistor (EnFET), wherein an ion sensing film of an ISFET is replaced by an enzyme film. The EnFET has been used to measure various solutions such as penicillin, urea, glucose, acetylcholine, and ethanol.

Several related arts regarding ISFET are disclosed in the following. U.S. Pat No. 2002/0090738 describes a micro-electrical device for analyzing biomaterial. The device can be used in rapid clinical detections and comprises a base sensing unit, a perm-selective layer, and a bio-layer (comprising bio-active layers and support matrixes).

U.S. Pat No. 4,816,118 discloses an ion-selective FET comprising a MOSFET gate layer (redox layer) as a sensing film which may improve the operation stability and response rate. The device is suited to measure the ion concentration in humans.

U.S. Pat No. 4,798,664 discloses a solid state ion sensing unit without a channel for passing fluid. The ion sensing unit comprises a conductive substrate, a redox layer covering the conductive substrate, and an ion-selective layer covering the redox layer. Additionally, a heat adjuster is installed in the redox layer.

U.S. Pat. No. 4,589,642 discloses an electrochemical sensing unit having a fixed enzyme film. First, a sized fillister having a pore is formed on the bottom of the cylindrical container. Next, the pore is covered by an ammonium ion selective film and a polyester film coated with urea enzyme, and the two films are tightly combined by the tension produced by the ion-selective film exceeding the pore. Polyvinyl chloride (PVC) serving as a substrate, bis(2-ethylhexyl)sebacate (DOS) serving as a polymerizing reagent, and nonactin serving as a sensing material are mixed to create the ion-selective film.

However, an ion-selective electrode with an extended gate FET and an ammonium ion selective film served as a sensing film fixed on an oxide layer formed on a substrate has not yet been provided.

### SUMMARY

An embodiment of the invention provides an ion-selective electrode comprising a metal oxide semiconductor field effect transistor (MOSFET) installed on a semiconductor substrate, a sensing unit comprising a substrate, an oxide layer on the substrate, an ammonium ion selective film fixed on the oxide layer, and a conductive line connecting the MOSFET and the sensing unit.

Also provided is a method of fabricating a sensing unit, comprising providing a conductive substrate, forming a SnO₂ film on the conductive substrate, installing a conductive line to connect the conductive substrate, forming an insulation layer to cover the conductive substrate, the SnO₂ film, and the conductive line, leaving two uncovered regions of the SnO₂ film and the conductive line, respectively, and forming an ammonium ion selective film on the uncovered region of the SnO₂ film.

Further provided is a method of detecting potential using the above ion-selective electrode, comprising providing a test solution to contact the ammonium ion selective film, receiving a voltage signal by a circuit connecting with the conductive line, and analyzing the voltage signal as a response to obtain an ammonium ion concentration of the test solution.

The ion-selective electrode can measure the ion concentration (such as [NH₄⁺]) ranging from normal to dangerous levels in humans.

A detailed description is given in the following with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a sensing unit structure comprising an ion-selective film, a SnO₂ layer, an ITO layer, and a glass substrate of an embodiment of the invention.

FIG. 2 is a graph plotting voltages against time of ammonium ion solution of various concentrations measured by an ion-selective electrode comprising PVC-COOH of an embodiment of the invention.

FIG. 3 is a graph plotting voltages against ammonium ion concentrations measured by the ion-selective electrode comprising PVC-COOH of an embodiment of the invention.

FIG. 4 is a graph plotting voltages against ammonium ion concentrations measured by five ion-selective electrodes comprising different compositions of ammonium ion selective films, respectively.

FIG. 5a shows a calibrated curve of the ion-selective electrode obtained with the buffer solutions which the concentration of Tris is fixed but EDTA is altered of an embodiment of the invention.

FIG. 5b shows a calibrated curve of the ion-selective electrode obtained with the buffer solutions which the concentration of EDTA is fixed but Tris is altered of an embodiment of the invention.

FIG. 6 shows the voltages and calibrated curves obtained with various pH, 5.5˜9.5, of test solutions of an embodiment of the invention.

FIG. 7 shows duration from response to recovery of a device of an embodiment of the invention.

FIG. 8 illustrates output voltages of various ammonium ion concentrations of an embodiment of the invention.

FIG. 9 shows a linear regression curve with variations in ammonium ion concentration of an embodiment of the invention.

FIG. 10 illustrates the ion-selective electrode of an embodiment of the invention.

FIG. 11 illustrates operational stability of the ion-selective electrode tested by the test solutions with concentrations of 10⁻⁴M to 10⁻²M of an embodiment of the invention.

FIG. 12 illustrates the storage stability of the ion-selective electrode of an embodiment of the invention.

### DETAILED DESCRIPTION

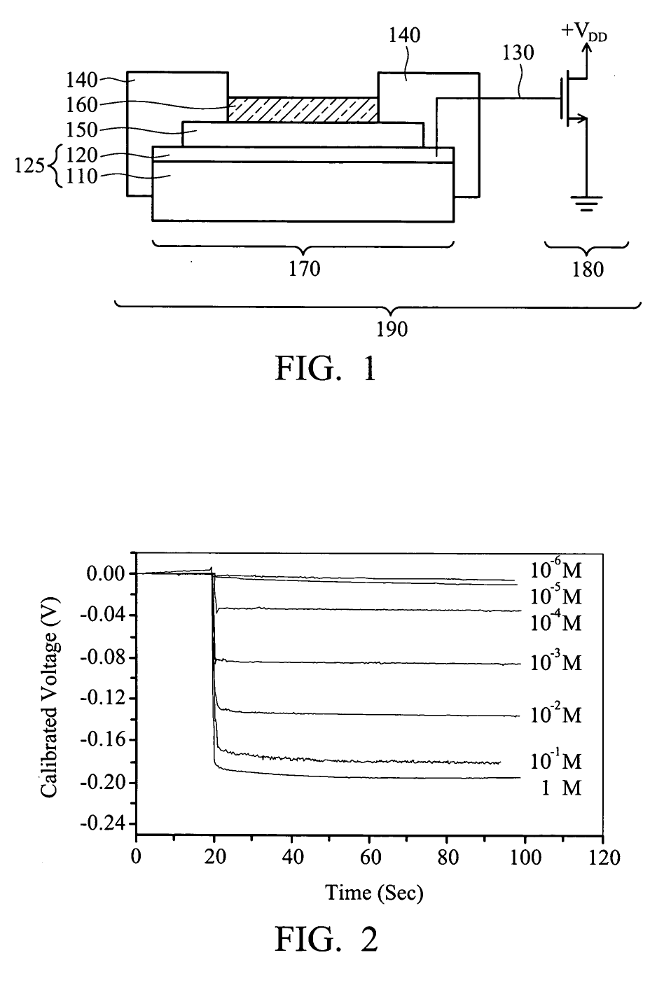

In FIG. 1, a sensing film of an ion-selective electrode 190 with an extended gate field effect transistor is extended above a gate, that is, a test solution contacts the sensing film, isolated from a metal oxide semiconductor field effect transistor (MOSFET).

The ion-selective electrode comprises a MOSFET 180, a sensing unit 170, and a conductive line 130. The MOSFET comprising a gate (oxide layer, such as SiO₂) is, for example, an n-type FET installed on a semiconductor substrate having a pair of source/drain regions located at the two sides of the gate. The gate is connected to the sensing unit with the conductive line to conduct electrical signals therefrom. Additionally, the MOSFET comprises such as a marketed amplifier LT1167 or FET CD4007.

The sensing unit 170 comprises a substrate 125, an oxide layer 150, and an ammonium ion selective film 160, wherein the substrate is a marketed conductive substrate such as an ITO sbstrate. The oxide layer, such as a SnO₂ layer, is deposited on the substrate by sputtering at a thickness of about 500˜3000 Å, preferably 1000˜2500 Å, and ideally 1500˜2000 Å. The ammonium ion selective film is fixed on the oxide layer, wherein the ammonium ion selective film comprises 20˜55 wt %, preferably 25˜40 wt %, ideally 30˜36 wt % of polyvinyl chloride (PVC) or polyvinyl chloride with carboxyl groups (PVC-COOH), 30˜135 wt %, preferably 40˜80 wt %, ideally 63˜69 wt % of bis(2-ethylhexyl)sebacate (DOS), and 0.5˜3 wt %, preferably 1˜2.5 wt %, ideally 1.2˜1.5 wt % of nonactin. The ammonium ion selective film provides superior electrical performance, minimization, and rapid reactivity so that test solutions can be rapidly tested thereby, reducing measurement time. Additionally, the ammonium ion selective film has a thickness of about 0.1˜20 μm, preferably 1˜15 μm, and ideally 5˜10 μm, and has an area of about 1˜36 mm², preferably 2˜25 mm², and ideally 4˜9 mm², depending on the process requirements. The sensing unit is connected to MOSFET with the conductive line 130 comprising any conductive material such as Al, Cu, Au, or combination thereof. Specifically, the conductive line connects the conductive substrate of the sensing unit and the gate of the MOSFET, such that voltage variations can be detected by the MOSFET. The connection between the sensing unit and the MOSFET of the present ion-selective electrode is separate type such as a plugged type, replacing sensing units to improve the process flexibility.

The ion-selective electrode further comprises an insulation layer 140 of, for example, epoxy resin, covering the sensing unit to isolate the test solution, achieving the electrical isolation, exposing only a portion of the sensing unit to subsequently contact the test solution.

After the SnO₂ layer is deposited on the conductive substrate, the conductive line connects to the conductive substrate, and the above elements are then covered by the insulation layer, exposing merely a portion of the SnO₂ layer to subsequently contact the test solution and a portion of the conductive line to subsequently connect the MOSFET. Finally, the ammonium ion selective film is formed on the exposed portion of the SnO₂ layer.

Formation of the ammonium ion selective film comprises mixing 20˜55 wt %, preferably 25˜40 wt %, ideally 30˜36 wt % of polyvinyl chloride (PVC) or polyvinyl chloride with carboxyl groups (PVC-COOH), 30˜135 wt %, preferably 40˜80 wt %, ideally 63˜69 wt % of bis(2-ethylhexyl)sebacate (DOS), and 0.5˜3 wt %, preferably 1˜2.5 wt %, ideally 1.2˜1.5 wt % of nonactin to form a mixture, adding the mixture into a solvent to form a mixed solution, and polymerizing the SnO₂ film by dropping the mixed solution on the exposed portion thereof to form the ammonium ion selective film fixed thereon.

The solvent is non-reactive to polyvinyl chloride (PVC) or polyvinyl chloride with carboxyl groups (PVC-COOH), bis(2-ethylhexyl)sebacate (DOS), and nonactin. The solvent comprises organic solvent, preferably tetra-hydrofuran, toluene, and ethanol. Additionally, the solvent has a weight percentage of about 65˜90%, preferably 70˜85, and best 75˜80% in the mixed solution.

When ammonium ion concentration is detected, the test solution containing the ammonium ion can contact the ammonium ion selective film to produce a voltage signal. Next, the voltage signal is received by a circuit connecting with the source/drain of the MOSFET, and the voltage signal is analyzed as a response to obtain the ammonium ion concentration of the test solution.

Embodiments of the ammonium ion selective electrode may obtain an optimal reaction curve with 0.5 mM and pH 7.5 of Tris/EDTA buffer solution, with detection scope of 10⁻⁵ to 1M, and average sensitivity thereof in the linear region 47.64 mV/pNH₄⁺.

### EXAMPLES

### Example 1

### Method for Fabricating Sensing Units

First, an ITO substrate of proper size was washed in methanol and deionized water for 15 min, respectively, by an ultrasonicator. A SnO₂ sensing film was then deposited on the ITO substrate at a thickness of about 2000 Å by sputtering, wherein the sputtering conditions comprise reactive gas ratio (O₂/Ar) of ¼, substrate temperature of 150° C., sputtering pressure of 20 mtorr, and deposition time of 30 min. After sputtering, a conductive line was fixed in a remaining space of the ITO substrate by silver glue. Next, the ITO substrate was dried in oven at 150° C. for 40 min and packaged by epoxy resin, leaving a sensing window of about 2×2 mm² exposing the sensing film. Finally, the ITO substrate was dried at 150° C. for 15 min to harden the epoxy resin.

Subsequently, a mixture of 33 mg of poly (vinyl chloride) carboxylated (PVC-COOH), 66 mg of (bis(2-ethylhexyl)sebacate (DOS), and 1 mg of nonactin was mixed with 0.375 ml of tetrahydrofuran (THF) for 5 min by the ultrasonicator to form a uniform ammonium ion selective solution. Finally, 2 μl of the ammonium ion selective solution was dropped on the sensing window (shaken for 20 min in deionized water) to fix an ammonium ion sensing film therein.

### Example 2

### Method for Fabricating Ion-Selective Electrodes

The conductive line extending from the substrate of the above ammonium ion sensing unit is a signal connection circuit.

### Example 3

### Measurement Experiment

A test solution contacting a portion of the sensing unit was measured by the above ion-selective electrode. Measuring data was then transmitted to an amplifier through a reference electrode and acquired by a digital measuring device.

The test solution was prepared as follows. First, a mixed solution of 20 mmol/l of tris(hydroxymethyl)aminomethane(tris) and 1.0 mmol/l of ethylenediaminetetraacetic acid(disodium salt) (EDTA) was added to 1000 ml of deionized water to form a buffer solution with pH 7.5, the pH adjusted by 0.5 M HCl. Test solutions containing ammonium ion of various concentrations (10⁻⁶, 10⁻⁵, 10⁻⁴, 10⁻³, 10⁻², 10⁻¹, and 1M) were then prepared by NH₄OH_{(eq)} and the buffer solution.

After each measurement was completed, the ion-selective electrode was placed in a dark tank at 4° C. until the next measurement.

FIG. 1 shows an ion-selective electrode with an extended gate field effect transistor of an embodiment of the invention. The electrode is disposable due to an inexpensive glass substrate, and sensing unit structure thereof comprises an ammonium ion selective film, a SnO₂ layer, an ITO layer, and a glass substrate.

FIG. 2 is a graph plotting calibrated voltages against time of ammonium ion solutions with various concentrations (10⁻⁶, 10⁻⁵, 10⁻⁴, 10⁻³, 10⁻², 10⁻¹, and 1M) measured by the ion-selective electrode comprising PVC-COOH of an embodiment of the invention.

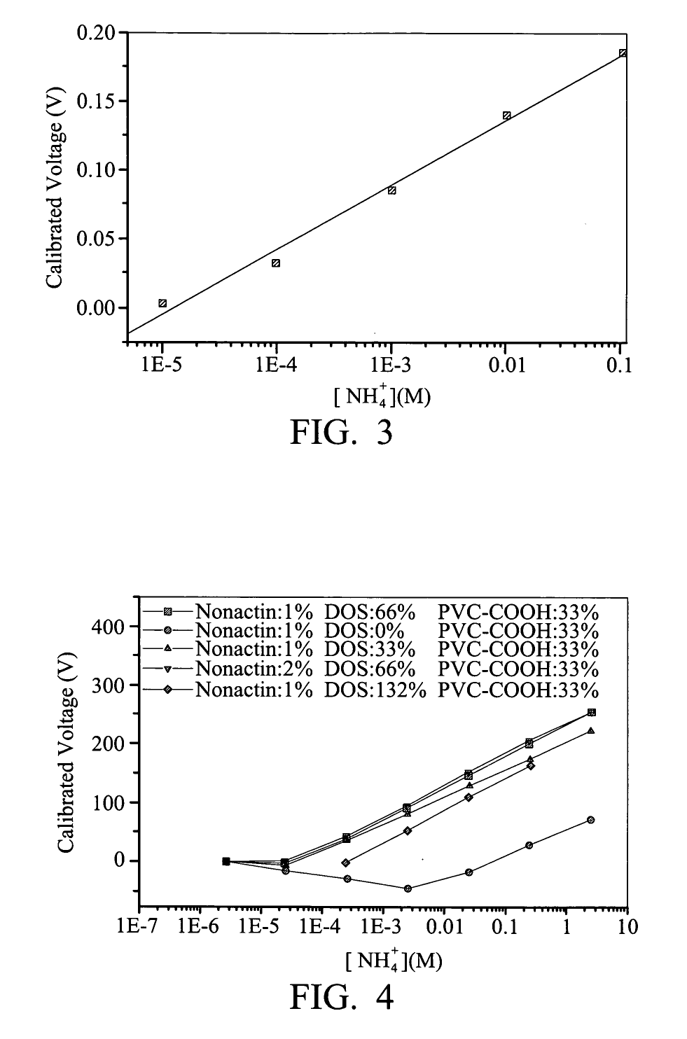

FIG. 3 is a graph plotting calibrated voltages against ammonium ion concentrations, wherein the sensitivity, 47.39 mV/pNH₄⁺, of the ion-selective electrode is obtained therefrom.

FIG. 4 is a graph plotting calibrated voltages against ammonium ion concentrations measured by five ion-selective electrodes comprising different compositions of ammonium ion selective films, respectively, wherein DOS significantly solidifies the ammonium ion selective films. For example, the ratios of DOS comprise 0%, 33%, 66%, and 132%, wherein the performance may be improved at a ratio of 66%, but deteriorate without adding DOS.

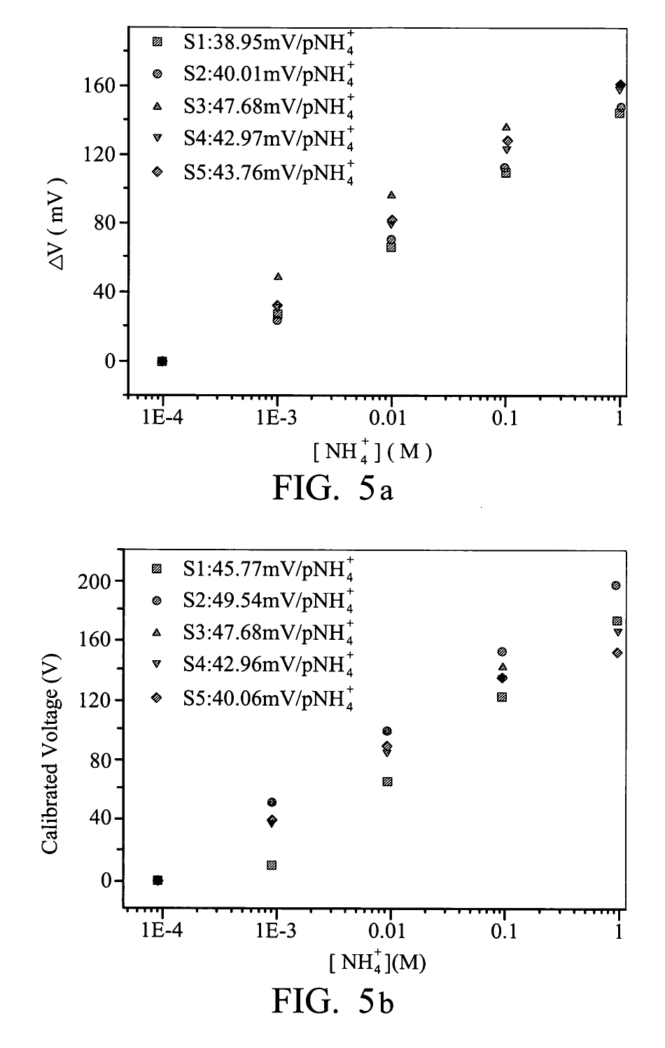

FIG. 5a shows a calibrated curve of the ion-selective electrode obtained with various buffer solutions in which the concentration of Tris is fixed but EDTA is altered, and FIG. 5b shows another calibrated curve thereof with various buffer solutions in which the concentration of EDTA is fixed but Tris is altered. The results of FIGS. 5a and 5b indicate that the calibrated voltages may not be significantly affected by altering the buffer solution concentrations.

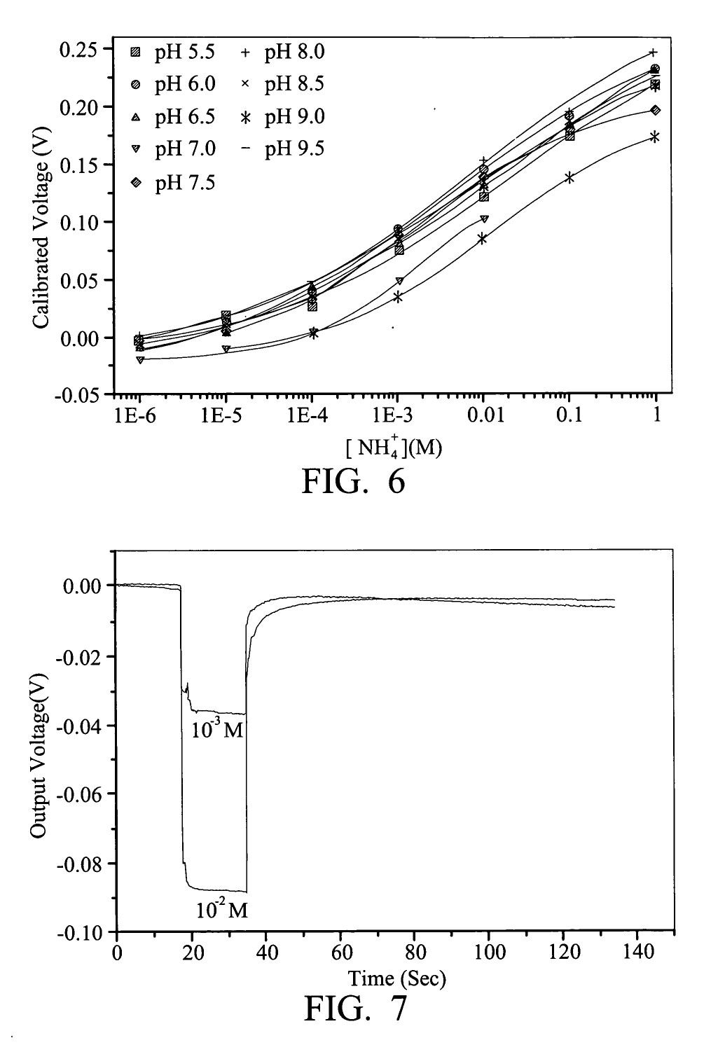

FIG. 6 shows the voltages and calibrated curves obtained at various initial pH test solutions comprising 5.5, 6.0, 6.5, 7.0, 7.5, 8.0, 8.5, 9.0, and 9.5.

FIG. 7 shows duration from response to recovery of a device. After the device is placed in the test solution for 15 sec, a response voltage of 90% of the maximum response voltage thereof is output, and after replacement in the buffer solution for 100 sec, the response voltage thereof slowly recovers to the initial value, wherein the buffer solution comprises 20 mmol/l of Tris and 1 mmol/l of EDTA.

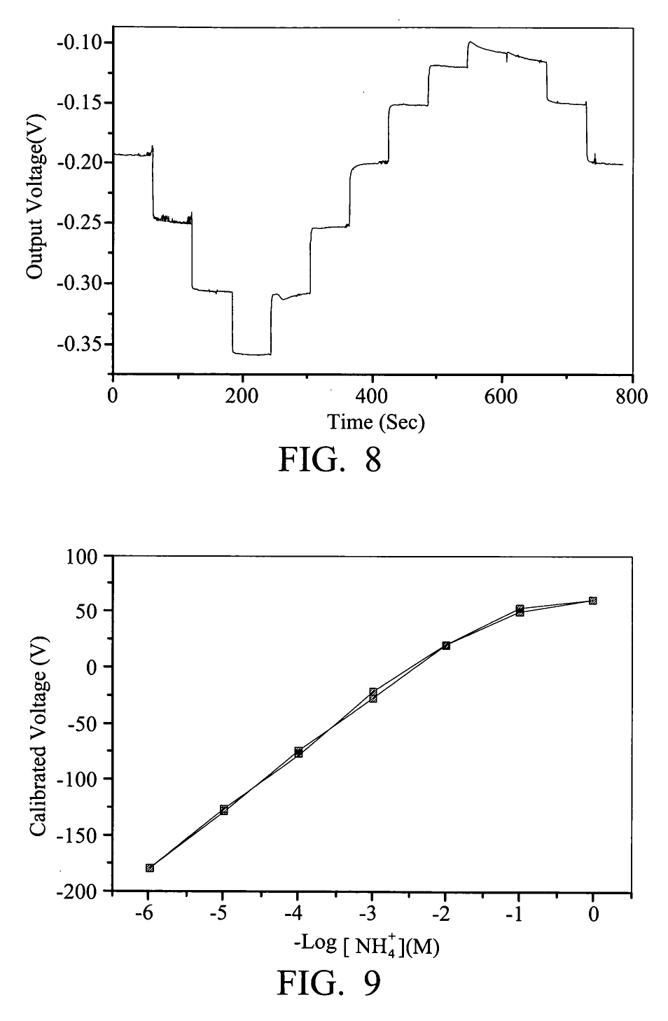

FIG. 8 illustrates output voltages of various ammonium ion concentrations, wherein the variation of the ion concentrations is 10⁻³M→10⁻²M→10⁻¹M→1M→10⁻¹M→10⁻²M→10⁻³M→10⁻⁴M→10⁻⁵M→10⁻⁶M→10⁻⁵M→10⁻⁴M→10⁻³M. The results of FIG. 8 indicate that the output voltage of the device may be distinct from the original, when the ion concentration is suddenly returned to the original, that is, hysteresis.

FIG. 9 shows a voltage linear regression curve with the variation of ammonium ion concentrations from 10⁻⁶M to 1M.

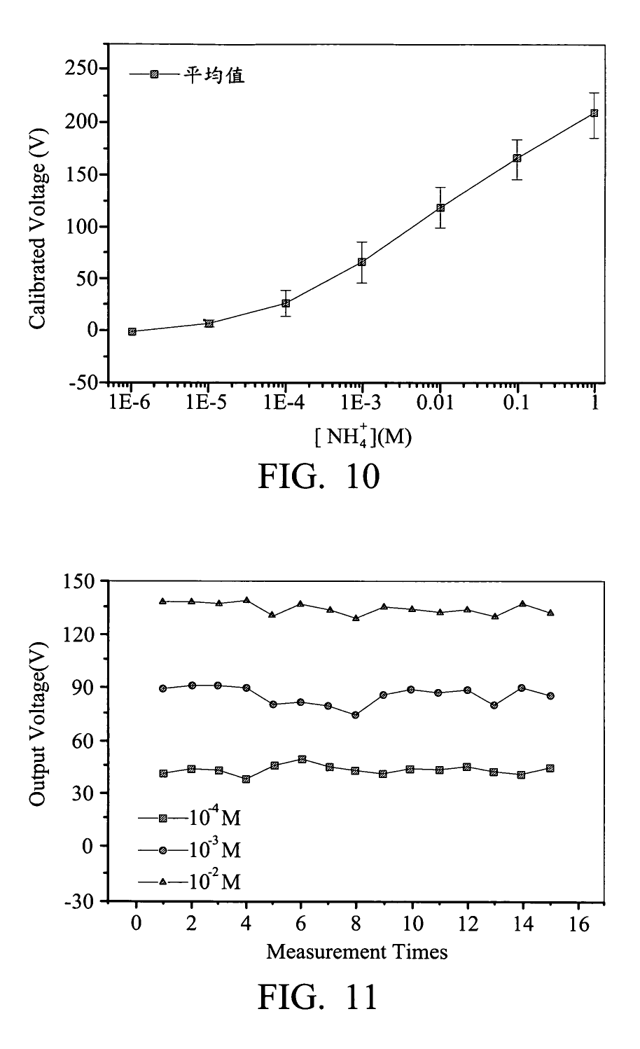

FIG. 10 illustrates a representation of the ion-selective electrode.

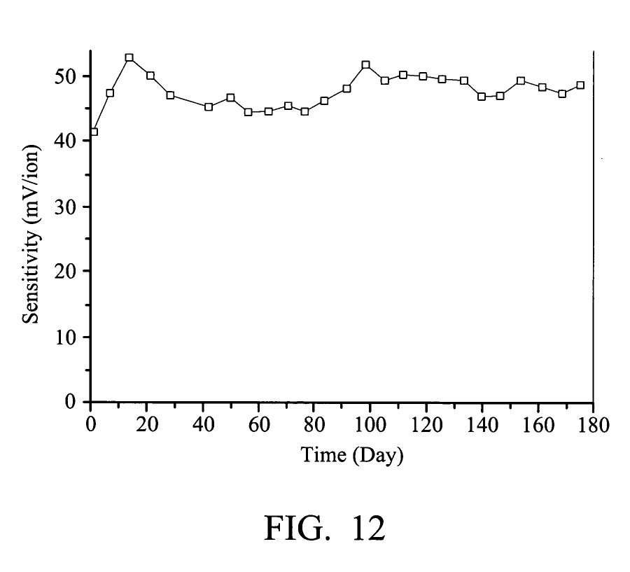

FIG. 11 illustrates the operational stability of the ion-selective electrode, that is, the stability of the output voltages of the device under continuous operation. The electrode is repeatedly used to measure the test solutions at concentrations of 10⁻⁴M to 10⁻²M with the buffer solution comprising 20 mmol/l of Tris and 1 mmol/l of EDTA to observe the stability of the output voltages thereof. Finally, FIG. 12 illustrates storage stability of the ion-selective electrode, as sensitivity of the device during long-term storage. The sensitivity of the ion-selective electrode is measured once per week to observe the alteration thereof, and the electrode is stored in dark at 4° C. The results of FIG. 12 indicate that the sensitivity of the ion-selective electrode can be maintained without decay for 175 days or more.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An ion-selective electrode with an extended gate field effect transistor, comprising:
a metal oxide semiconductor field effect transistor (MOSFET), installed on a semiconductor substrate;
a sensing unit, comprising a substrate, an oxide layer on the substrate, and an ammonium ion selective film fixed on the oxide layer; and
a conductive line, connecting the MOSFET and the sensing unit.

2. The ion-selective electrode as claimed in claim 1, wherein the ammonium ion selective film comprises 20˜55 wt % of polyvinyl chloride (PVC) or polyvinyl chloride with carboxyl groups (PVC-COOH), 30˜135 wt % of bis(2-ethylhexyl)sebacate (DOS), and 0.5˜3 wt % of nonactin.

3. The ion-selective electrode as claimed in claim 1, wherein the substrate is an ITO substrate.

4. The ion-selective electrode as claimed in claim 1, wherein the oxide layer is a SnO₂ layer.

5. The ion-selective electrode as claimed in claim 4, wherein the SnO₂ layer is deposited on the substrate by sputtering.

6. The ion-selective electrode as claimed in claim 5, wherein the SnO₂ layer has a thickness of about 1500˜2000 Å.

7. The ion-selective electrode as claimed in claim 1, further comprising an insulation layer covering the sensing unit.

8. The ion-selective electrode as claimed in claim 7, wherein the insulation layer comprises epoxy resin.

9. The ion-selective electrode as claimed in claim 1, wherein the conductive line has two ends to connect the MOSFET and the sensing unit by connectors, respectively.

10. The ion-selective electrode as claimed in claim 1, wherein the conductive line comprises Al.

11. The ion-selective electrode as claimed in claim 1, wherein the MOSFET is an n-type FET.

12. A method of fabricating a sensing unit, comprising:
providing a conductive substrate;
forming a SnO₂ film on the conductive substrate;
installing a conductive line to connect the conductive substrate;
forming an insulation layer to cover the conductive substrate, the SnO₂ film, and the conductive line, leaving two uncovered regions of the SnO₂ film and the conductive line, respectively; and
forming an ammonium ion selective film on the uncovered region of the SnO₂ film, wherein the ammonium ion selective film comprises ammonium ion selections.

13. The method as claimed in claim 12, wherein the SnO₂ layer is formed on the conductive substrate by sputtering.

14. The method as claimed in claim 13, wherein the SnO₂ layer has a thickness of about 1500˜2000 Å.

15. The method as claimed in claim 12, wherein formation of ammonium ion selective film on the uncovered region of the SnO₂ film comprises mixing 20˜55 wt % of polyvinyl chloride (PVC) or polyvinyl chloride with carboxyl groups (PVC-COOH), 30˜135 wt % of bis(2-ethylhexyl)sebacate (DOS), and 0.5˜3 wt % of nonactin to form a mixture, adding the mixture to a solvent to form a mixed solution, and polymerizing the SnO₂ film by dropping the mixed solution on the uncovered region thereon.

16. The method as claimed in claim 12, wherein the insulation layer comprises epoxy resin.

17. A method of detecting potential using the ion-selective electrode as claimed in claim 1, comprising:
providing a test solution to contact the ammonium ion selective film;
receiving a voltage signal by a circuit connecting with the conductive line; and
analyzing the voltage signal as a response to obtain an ammonium ion concentration of the test solution.
